(19) United States
(12) Patent Application Publication
(10) Pub. No.: US 2026/0195962 A1
(43) Pub. Date: Jul. 9, 2026

(54) RAY TRACING COMPUTING DEVICE AND COMPUTING METHOD

(71) Applicants: SAMSUNG ELECTRONICS CO., LTD., Suwon-si (KR); KOREA ADVANCED INSTITUTE OF SCIENCE AND TECHNOLOGY, Daejeon (KR)

(72) Inventors: Young-Gul WON, Suwon-si (KR); Junil CHOI, Daejeon (KR); Hyuckjin CHOI, Daejeon (KR)

(73) Assignees: SAMSUNG ELECTRONICS CO., LTD., Suwon-si (KR); KOREA ADVANCED INSTITUTE OF SCIENCE AND TECHNOLOGY, Daejeon (KR)

(21) Appl. No.: 19/415,175

(22) Filed: Dec. 10, 2025

(30) Foreign Application Priority Data
Jan. 3, 2025 (KR) 10-2025-0000913

(51) Int. Cl. G06T 15/06

(52) U.S. Cl. CPC G06T 15/06; G06T 2210/12; G06T 2210/21

(57) ABSTRACT

A ray tracing computing method and a ray tracing computing device using the method are provided. The ray tracing computing method includes generating, in image data, a first bounding box comprising at least one first object and a second bounding box comprising at least one second object, the second bounding box being distinguished from the first bounding box; extracting, from among rays in the image data, candidate rays intersecting with the first bounding box; extracting at least one target ray, based on the candidate rays and at least one first polygon corresponding to the at least one first object comprised in the first bounding box; and examining an intersection between the at least one target ray and at least one second polygon corresponding to the at least one second object comprised in the second bounding box based on the at least one target ray and the second bounding box.

### CROSS-REFERENCE TO RELATED APPLICATION

This application is based on and claims priority from Korean Patent Application No. 10-2025-0000913, filed on Jan. 3, 2025, in the Korean Intellectual Property Office, the disclosure of which is incorporated herein by reference in its entirety.

### BACKGROUND

### 1. Field

Methods and apparatuses consistent with embodiments relate to ray tracing technology.

### 2. Description of Related Art

In the field of wireless communication, technology for tracking a moving path of radio waves may be required for accurate transmission of a signal. In particular, it is important to predict a path of radio waves by considering a phenomenon in which the radio waves are reflected, refracted, and/or diffracted in a complex environment. To achieve this purpose, ray tracing technology may be used in the field of wireless communication. Ray tracing technology is a method of analyzing a characteristic of a ray based on simulating a moving path of the ray. To improve the efficiency of ray tracing, a collision examination between a ray and an object needs to be effectively performed. Therefore, there is a need for technology for improving the efficiency of a collision examination to improve the performance of ray tracing technology.

### SUMMARY

One or more example embodiments may address at least the above problems and/or disadvantages and other disadvantages not described above. Also, the embodiments are not required to overcome the disadvantages described above, and an embodiment may not overcome any of the problems described above.

According to an aspect of an example embodiment, there is provided a ray tracing computing method performed by at least one processor, the ray tracing computing method including: obtaining image data including objects; generating, in the image data, a first bounding box including at least one first object of the objects and a second bounding box including at least one second object of the objects, the second bounding box being distinguished from the first bounding box; extracting, from among rays in the image data, candidate rays intersecting with the first bounding box; extracting at least one target ray, based on the candidate rays and at least one first polygon corresponding to the at least one first object included in the first bounding box; and examining an intersection between the at least one target ray and at least one second polygon corresponding to the at least one second object included in the second bounding box based on the at least one target ray and the second bounding box.

The extracting the at least one target ray may include extracting the at least one target ray by removing, from the candidate rays, a ray intersecting with at least one of the at least one first polygon.

The at least one target ray may include a first ray propagating from a first point to a second point, and the examining the intersection between the at least one target ray and the at least one second polygon may include: based on the first ray and a first vertex of a target polygon among the at least one second polygon, calculating an intersection point between the first ray and a plane including the target polygon; and determining whether the intersection point is located inside the target polygon based on vector values corresponding to edges of the target polygon and a vector value based on the first vertex and the intersection point.

The calculating the intersection point may include: producing a first dot product result between a first direction vector from the first point to the second point and a normal vector corresponding to the target polygon; producing a second dot product result between a second direction vector from the first point to the first vertex and the normal vector; and calculating the intersection point based on a ratio between the first dot product result and the second dot product result.

The determining whether the intersection point is located inside the target polygon may include producing distance weight values between the intersection point and each of other vertices, except for the first vertex, of the target polygon based on the vector values corresponding to the edges of the target polygon and a third direction vector from the first vertex to the intersection point.

The determining whether the intersection point is located inside the target polygon further may include: determining whether the ratio between the first dot product result and the second dot product result falls within a first threshold range that is predetermined; determining whether each of the distance weight values falls within a second threshold range that is predetermined; and determining whether a sum result of the distance weight values falls within a third threshold range that is predetermined.

The examining the intersection between the at least one target ray and the at least one second polygon may include performing an intersection examination between the at least one target ray and the at least one second polygon based on a number of the candidate rays and a number of the at least one second polygon.

The generating the first bounding box and the second bounding box may include: setting the first bounding box and the second bounding box as parent bounding boxes corresponding to a first hierarchy; and generating child bounding boxes including at least one of the at least one first object included in the first bounding box and corresponding to a second hierarchy, which is a lower hierarchy of the first hierarchy.

The generating the first bounding box and the second bounding box may include: obtaining predetermined coordinate axes corresponding to the image data; and generating the first bounding box and the second bounding box, each of which includes edges that are parallel to a direction of each of the predetermined coordinate axes.

The candidate rays may include a first ray propagating from a first point to a second point and the extracting the candidate rays may include: setting an intersection point of the first ray with a target object among the objects as a starting point of a second ray, which is distinguished from the first ray; setting the second ray based on the intersection point and a new point on the image data; and determining whether the second ray and the first bounding box intersect with each other.

According to an aspect of an example embodiment, there is provided a non-transitory computer-readable storage medium storing computer program, the computer program being executable by at least one processor to perform: obtaining image data including objects; generating, in the image data, a first bounding box including at least one first object of the objects and a second bounding box including at least one second object of the objects, the second bounding box being distinguished from the first bounding box; extracting, from among rays in the image data, candidate rays intersecting with the first bounding box; extracting at least one target ray, based on the candidate rays and at least one first polygon corresponding to the at least one first object included in the first bounding box; and examining an intersection between the at least one target ray and at least one second polygon corresponding to the at least one second object included in the second bounding box based on the at least one target ray and the second bounding box.

According to an aspect of an example embodiment, there is provided a ray tracing computing device including: a communicator configured to obtain image data including objects; a memory configured to store the image data and instructions; and at least one processor configured to, by executing the instructions: generate, in the image data, a first bounding box including at least one first object of the objects and a second bounding box including at least one second object of the objects, the second bounding box being distinguished from the first bounding box; extract, from among rays in the image data, candidate rays intersecting with the first bounding box; extract at least one target ray, based on the candidate rays and at least one first polygon corresponding to the at least one first object included in the first bounding box; and examine an intersection between the at least one target ray and at least one second polygon corresponding to the at least one second object included in the second bounding box based on the at least one target ray and the second bounding box.

The at least one processor may be configured to extract the at least one target ray by removing, from the candidate rays, a ray intersecting with at least one of the at least one first polygon.

The at least one target ray may include a first ray propagating from a first point to a second point, and the at least one processor may be configured to, based on the first ray and a first vertex of a target polygon among the at least one second polygon, calculate an intersection point between the first ray and a plane including the target polygon, and configured to determine whether the intersection point is located inside the target polygon based on vector values corresponding to edges of the target polygon and a vector value based on the first vertex and the intersection point.

The at least one processor may be configured to, in calculating the intersection point, produce a first dot product result between a first direction vector from the first point to the second point and a normal vector corresponding to the target polygon, produce a second dot product result between a second direction vector from the first point to the first vertex and the normal vector, and calculate the intersection point based on a ratio between the first dot product result and the second dot product result.

The at least one processor may be configured to determine whether the intersection point is located inside the target polygon by producing distance weight values between the intersection point and each of other vertices, except for the first vertex, of the at least one second polygon based on the vector values corresponding to the edges of the target polygon and a third direction vector from the first vertex to the intersection point.

The at least one processor may be configured to determine whether the intersection point is located inside the target polygon by determining whether the ratio between the first dot product result and the second dot product result falls within a first threshold range that is predetermined, determining whether each of the distance weight values falls within a second threshold range that is predetermined, and determining whether a sum result of the distance weight values falls within a third threshold range that is predetermined.

The at least one processor may be configured to perform an intersection examination between the at least one target ray and the at least one second polygon based on a number of the candidate rays and a number of the at least one second polygon.

The at least one processor may be configured to set the first bounding box and the second bounding box as parent bounding boxes corresponding to the same hierarchy, a first hierarchy, and configured to generate child bounding boxes including at least one of the at least one first object included in the first bounding box and corresponding to a second hierarchy, which is a lower hierarchy of the first hierarchy.

The at least one processor may be configured to obtain predetermined coordinate axes corresponding to the image data and configured to generate the first bounding box and the second bounding box, each of which includes edges that are parallel to a direction of each of the predetermined coordinate axes.

### BRIEF DESCRIPTION OF DRAWINGS

The above and/or other aspects will be more apparent by describing certain example embodiments, taken in conjunction with the accompanying drawings, in which:

FIG. 1 is a diagram illustrating ray tracing;

FIG. 2 is a flowchart illustrating a method performed by a ray tracing computing device, according to an embodiment;

FIG. 3 is a diagram illustrating a method of forming a hierarchical bounding box by a ray tracing computing device, according to an embodiment;

FIG. 4 is a flowchart illustrating a method of extracting target rays by a ray tracing computing device, according to an embodiment;

FIG. 5 illustrates a process in which a ray tracing computing device dynamically indexes target rays, according to an embodiment;

FIG. 6 is a diagram illustrating that a ray tracing computing device extracts target rays from among virtual rays expressed as starting points and arrival points on image data, according to an embodiment;

FIGS. 7 and 8 are a flowchart and a diagram illustrating a method in which a ray tracing computing device performs an intersection examination between rays and polygons forming objects, according to embodiments; and

FIG. 9 is a block diagram illustrating an example of a configuration of a ray tracing computing device, according to an embodiment.

### DETAILED DESCRIPTION

The following detailed structural and/or functional description is provided as an example only and various alterations and modifications may be made to example embodiments described herein. Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, the example embodiments are described in detail with reference to the accompanying drawings. When describing the embodiments with reference to the accompanying drawings, like reference numerals refer to like components and a repeated description related thereto will be omitted.

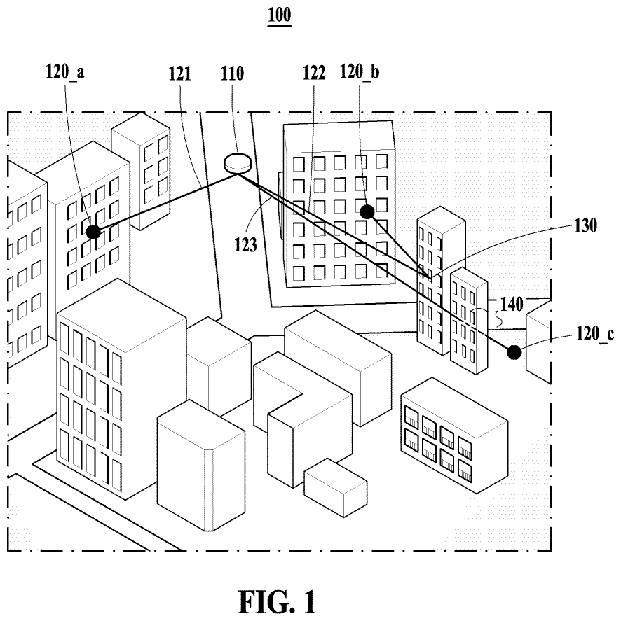

FIG. 1 is a diagram illustrating ray tracing.

FIG. 1 illustrates image data 100, which includes objects, and first, second, and third signals 121, 122, and 123, which move on the image data 100. For example, FIG. 1 illustrates the first, second, and third signals 121, 122, and 123 generated at a first point 110. Here, the first point 110 may indicate a point where a transmitter is located. That is, the first point 110 may indicate a starting point of a signal generated by the transmitter. In addition, first, second, and third arrival points 120_a, 120_b, and 120_c may receive each of the first, second, and third signals 121, 122, and 123 generated at the first point 110. For reference, it may be assumed that a receiver is located at each of the first, second, and third arrival points 120_a, 120_b, and 120_c .

For example, the first signal 121 may indicate a signal propagating from the first point 110 to the first arrival point 120_a. The first signal 121 may indicate a signal in which any object is not placed on a path propagating from the first point 110 to the first arrival point 120_a. For example, any object may be a building, a tree, or an obstacle including an installation located on a propagation path, but types of objects included in the image data 100 are not limited thereto.

In another example, the second signal 122 may indicate a signal propagating from the first point 110 to the second arrival point 120_b. The second signal 122 may intersect with an object in at least one collision point 130 while propagating from the first point 110 to the second arrival point 120_b. The second signal 122 may indicate a signal reflected from the at least one collision point 130 and reaching the second arrival point 120_b. Although FIG. 1 illustrates the second signal 122 in which a signal collides with an object one time, in the ray tracing simulation process, a signal may collide with objects multiple times.

In another example, the third signal 123 may indicate a signal propagating from the first point 110 to the third arrival point 120_c. The third signal 123 may be diffracted, scattered, and/or transmitted based on an object while propagating from the first point 110 to the third arrival point 120c. A path on which the third signal 123 propagates from the first point 110 to the third arrival point 120_c may include a blockage section 140. The blockage section 140 may indicate a section in which propagation of the third signal 123 is interrupted by an object.

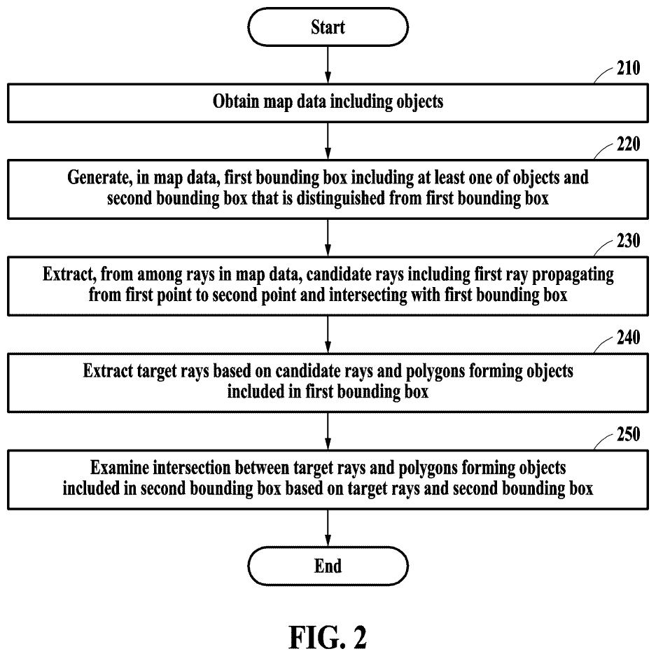

Ray tracing technology may refer to technology that accurately predicts the paths of the first, second, and third signals 121, 122, and 123 described above and implements a virtual space to look like a real space based on each of the first, second, and third signals 121, 122, and 123. For example, ray tracing technology may be used to predict an accurate location where each of the first, second, and third signals 121, 122, and 123, which start from the first point 110, arrive. Here, since an obstacle is not included in the propagation path of the first signal 121, in order for the first signal 121 to reach the first arrival point 120_a, the first signal 121 may propagate along a straight path connecting the first point 110 to the first arrival point 120_a. In contrast, since the second signal 122 may be reflected by an object, the second signal 122 may need to accurately identify a surface of the object to reach the second arrival point 120_b. In addition, since the third signal 123, may undergo diffraction, scattering, and/or transmission through the object, in order for the third signal 123 to reach the third arrival point 120_c, the third signal 123 may need to accurately identify the propagation path of the third signal 123 that is changed by diffraction, scattering, and/or transmission. An amount of ray tracing computation for the second signal 122 and the third signal 123 that collide with an object on the propagation path may be higher than an amount of ray tracing computation for the first signal 121 that has no object on the propagation path. For example, in ray tracing technology, a reflection path search may be performed on the second signal 122, and a path blockage examination may be performed on the third signal 123. Accordingly, to implement ray tracing technology, technology for quickly searching for a point (e.g., the at least one collision point 130 or a point that is close to the first point 110 among points in the blockage section 140) where the first, second, and third signals 121, 122, and 123 intersect with an object may be required. Hereinafter, the technology is described in detail with reference to FIGS. 2 to 9.

FIG. 2 is a flowchart illustrating a method performed by a ray tracing computing device, according to an embodiment.

In operation 210, according to an embodiment, a ray tracing computing device (hereinafter, referred to as an electronic device) may obtain image data including objects. The image data may include two-dimensional (2D) map data or three-dimensional (3D) map data. Hereinafter, it is mainly described an example where the image data is 3D map data. As described above with reference to FIG. 1, the objects may include a tree, a building, or an artificial structure displayed on the image data. The electronic device may receive image data for a certain area through, for example, wired and/or wireless communication with an external device, an external server, and/or an external cloud. For example, the electronic device may directly obtain the image data based on a global positioning system (GPS) signal, wireless network information, and/or moving path data. In an example, the electronic device may provide the image data for a certain area with reference to offline image data that is previously stored in local storage. However, a method of obtaining the image data by the electronic device is not limited thereto.

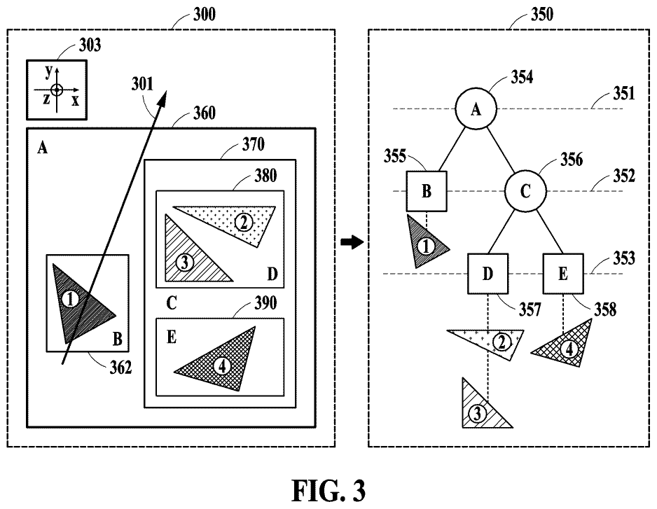

In operation 220, according to an embodiment, the electronic device may generate, in the image data, bounding boxes including at least one of the objects included in the image data. For example, the electronic device may generate the bounding boxes hierarchically. For example, the electronic device may generate a zeroth bounding box including all objects included in the image data. The zeroth bounding box including all objects included in the image data may correspond to a zeroth layer. For reference, the zeroth layer may indicate a highest layer among layers of the bounding boxes. The electronic device may set the zeroth bounding box corresponding to the zeroth layer as a parent bounding box. The electronic device may generate child bounding boxes included in a set parent bounding box. For example, the electronic device may generate a first bounding box including at least one object of the objects included in the zeroth bounding box and a second bounding box including at least one another object of the objects included in the zeroth bounding box and that is distinguished from the first bounding box. The first bounding box and the second bounding box may be included in the same layer, which is a first layer. Here, the first layer may be considered as a lower layer of the zeroth layer. A method of hierarchically generating the bounding boxes by the electronic device according to an embodiment will be described in detail later with reference to FIG. 3.

In operation 230, according to an embodiment, the electronic device may extract, from among rays in the image data, candidate rays intersecting with the first bounding box. For example, the electronic device may determine whether a first ray propagating from a first point to a second point on the image data intersects with the first bounding box. For example, the electronic device may generate a straight line connecting the first point to the second point. The electronic device may set the first point as a starting point of the first ray, set the second point as an arrival point of the first ray, and set the straight line connecting the first point to the second point as the first ray. The first ray may indicate a straight line, which assumes that there is no object corresponding to an obstacle on the path from the first point to the second point. The electronic device may set different starting points and arrival points that match one-on-one with the starting points on the image data, similar to a method of setting the first ray as described above. The electronic device may generate, as the rays, straight lines connecting the starting points to the arrival points that respectively match the starting points. The electronic device may extract the candidate rays intersecting with the first bounding box from among the generated rays. The candidate rays may also be used to determine whether the first bounding box intersects with objects in lower bounding boxes of the first bounding box. Accordingly, the electronic device may reduce a number of rays to be computed by identifying whether the rays intersect with a bounding box before determining whether the rays intersect with objects.

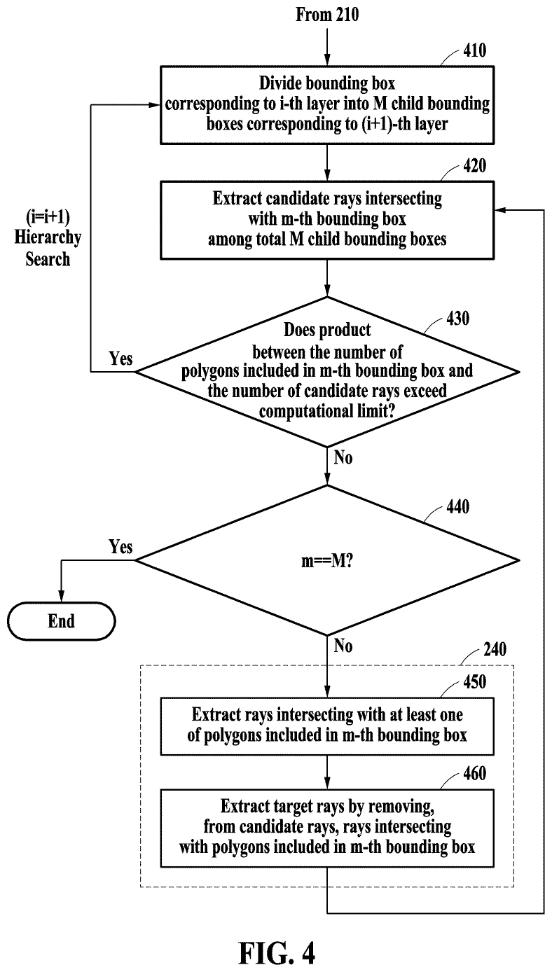

In operation 240, according to an embodiment, the electronic device may determine whether the candidate rays intersect with a polygon forming the at least one object included in the first bounding box. In the following descriptions, it is assumed that each of the first bounding box and the second bounding box includes two or more objects, but the disclosure is not limited thereto. Polygons forming the objects included in the first bounding box may include, for example, triangles and/or quadrangles but are not limited thereto. The polygons may indicate smallest unit elements forming surfaces of the objects. The electronic device may extract rays intersecting with at least one of the polygons forming the objects included in the first bounding box. For example, the electronic device may determine that the rays intersecting with at least one of the polygons forming the objects included in the first bounding box are rays in which a blockage has occurred by an object on a propagation path thereof. The electronic device may extract target rays including the first ray by removing the extracted rays from the candidate rays described above. An operation in which the electronic device extracts the target rays according to one or more embodiments will be described in detail later with reference to FIGS. 4 to 6.

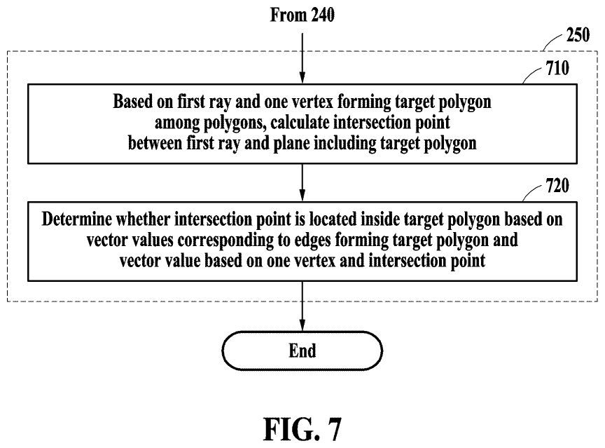

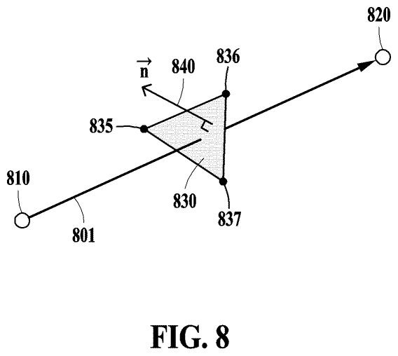

In operation 250, according to an embodiment, the electronic device may examine an intersection between the target rays and polygons forming objects included in the second bounding box based on the target rays and the second bounding box. For example, the electronic device may extract rays intersecting with the second bounding box from among the target rays. The electronic device may examine whether the rays intersecting with the second bounding box intersect with the polygons forming the objects included in the second bounding box. For example, the electronic device may calculate an intersection point where a plane including a target polygon among the polygons forming the objects included in the second bounding box intersects with the rays intersecting with the second bounding box. After the intersection point is calculated, the electronic device may determine whether the intersection point is located inside the target polygon. Specifically, the electronic device may obtain data on one vertex forming the target polygon among the polygons forming the objects included in the second bounding box. The electronic device may obtain a first direction vector from the first point corresponding to the starting point of the first ray to the second point corresponding to the arrival point of the first ray. The electronic device may produce a first dot product result between the first direction vector and a normal vector corresponding to the target polygon. The electronic device may obtain a second direction vector from the first point to one vertex corresponding to the target polygon. The electronic device may produce a second dot product result between the second direction vector and the normal vector corresponding to the target polygon. The electronic device may calculate the intersection point based on a ratio between the produced first dot product result and the produced second dot product result. The electronic device may determine whether the calculated intersection point is located inside the target polygon. For example, the electronic device may produce vector values corresponding to edges forming the target polygon. In addition, the electronic device may produce a vector value having a direction from the first point to a target point based on the calculated intersection point and one vertex corresponding to the target polygon. The electronic device may determine whether the intersection point is located inside the target polygon based on a computation between the produced vector values corresponding to the edges and the vector value having a direction from the first point to the target point. In a comparative embodiment, it may be possible to examine (or determine) whether the polygons forming the objects included in the second bounding box intersect with the rays intersecting with the second bounding box based on the Möller-Trumbore algorithm. Specifically, the Möller-Trumbore algorithm may include processes of identifying whether a ray and a polygon are parallel to each other, obtaining an intersection point between the ray and a plane including the polygon, and exploring whether the intersection point is located inside the polygon. Unlike the comparative embodiment, the electronic device according to an embodiment may support a parallel intersection examination between the polygons and the rays. A method in which the electronic device examines the intersection between the polygons and the rays will be described in detail later with reference to FIGS. 7 and 8.

FIG. 3 is a diagram illustrating a method of forming a hierarchical bounding box by a ray tracing computing device, according to an embodiment.

Referring to FIG. 3, according to an embodiment, a ray tracing computing device (hereinafter, referred to as an electronic device) may hierarchically generate zeroth, first, second, third, and fourth bounding boxes 360, 362, 370, 380, and 390 including at least one of objects included in image data. FIG. 3 describes a method of generating the zeroth, first, second, third, and fourth bounding boxes 360, 362, 370, 380, and 390 of the electronic device based on image data 300, which is assumed to correspond to a plan view of the image data 100 of FIG. 1.

In an embodiment, the electronic device may obtain coordinate axes 303, which are predetermined, corresponding to the image data 300. For example, as shown in FIG. 3, the electronic device may obtain the coordinate axes 303 including a positive direction of an x-axis from left to right in FIG. 3, a positive direction of a y-axis from bottom to top in FIG. 3, and a positive direction of a z-axis in a direction forward from a plane representing FIG. 3. The electronic device may generate the zeroth, first, second, third, and fourth bounding boxes 360, 362, 370, 380, and 390 to include edges that are parallel to a direction of each of the coordinate axes 303 that are obtained. For example, when the image data 300 is 2D, the electronic device may generate the zeroth, first, second, third, and fourth bounding boxes 360, 362, 370, 380, and 390 including a width that is parallel to the x-axis and a length that is parallel to the y-axis. In another example, when the image data 300 is 3D, the electronic device may generate the zeroth, first, second, third, and fourth bounding boxes 360, 362, 370, 380, and 390 including a width that is parallel to the x-axis, a length that is parallel to the y-axis, and a height that is parallel to the z-axis.

Objects (e.g., \textcircled{1}, \textcircled{2}, \textcircled{3}, and \textcircled{4}) may be displayed on the image data 300. The electronic device may hierarchically generate the zeroth, first, second, third, and fourth bounding boxes 360, 362, 370, 380, and 390 including at least one of the objects. For example, the hierarchy of the zeroth, first, second, third, and fourth bounding boxes 360, 362, 370, 380, and 390 generated by the electronic device may be expressed as a tree 350. Hereinafter, for ease of description, the zeroth, first, second, third, and fourth bounding boxes 360, 362, 370, 380, and 390 respectively correspond to zeroth, first, second, third, and fourth nodes 354, 355, 356, 357, and 358 included in the tree 350. For example, the zeroth bounding box 360 may correspond to the zeroth node 354 included in a zeroth layer 351 in the tree 350. For example, the first bounding box 362 and the second bounding box 370 may respectively correspond to the first node 355 and the second node 356 included in the same layer, which is a first layer 352. For example, the third bounding box 380 and the fourth bounding box 390 may respectively correspond to the third node 357 and the fourth node 358 included in the same layer, which is a second layer 353. In addition, the objects (e.g., \textcircled{1}, \textcircled{2}, \textcircled{3}, and \textcircled{4}) in the tree 350 may be expressed as leaf nodes of a bounding box including a corresponding object.

In the tree 350, the zeroth layer 351 including the zeroth node 354 may indicate an uppermost layer that does not have an upper layer thereof but has the first layer 352 and the second layer 353, which are lower layers thereof. The electronic device may set the zeroth node 354 as a parent node and generate, as child nodes, lower nodes (e.g., the first node 355 and the second node 356) that are directly connected to the zeroth node 354. That is, the electronic device may set the zeroth bounding box 360 as a parent bounding box. In addition, the electronic device may generate the first bounding box 362 including ‘object \textcircled{1}’ among the objects (e.g., \textcircled{1}, \textcircled{2}, \textcircled{3}, and \textcircled{4}) included in the zeroth bounding box 360 and the second bounding box 370 including ‘objects \textcircled{2}, \textcircled{3}, and \textcircled{4}’ as child bounding boxes for the zeroth bounding box 360. In a similar way, the second bounding box 370 including three different objects (e.g., \textcircled{2}, \textcircled{3}, and \textcircled{4}) may generate the third bounding box 380 including ‘objects \textcircled{2} and \textcircled{3}’ and the fourth bounding box 390 including ‘object \textcircled{4}’ as child bounding boxes.

Thus, according to an embodiment, the electronic device may hierarchically generate the bounding boxes in an order of bounding boxes included in an upper layer to bounding boxes included in a lower layer. The electronic device may perform, among the hierarchically generated bounding boxes, an intersection examination on an object (e.g., \textcircled{1}) included in the bounding boxes (e.g., the zeroth bounding box 360 and the first bounding box 362) intersecting with a ray 301. In this manner, the electronic device may reduce an unnecessary computation (e.g., an intersection examination on each of the objects \textcircled{2}, \textcircled{3}, and \textcircled{4}).

FIG. 4 is a flowchart illustrating a method of extracting target rays by a ray tracing computing device, according to an embodiment.

In operation 410, according to an embodiment, a ray tracing computing device (hereinafter, referred to as an electronic device) may divide a bounding box corresponding to an i-th layer into M child bounding boxes corresponding to an (i+1)-th layer. Here, i and M may indicate integers greater than or equal to 1. For example, as shown in FIG. 3, the electronic device may divide a bounding box (e.g., the second bounding box 370 of FIG. 3) corresponding to a first layer (e.g., the first layer 352 of FIG. 3) into two child bounding boxes (e.g., the third bounding box 380 and the fourth bounding box 390 of FIG. 3) included in the second layer 353. That is, the electronic device may generate lower bounding boxes to be included in a bounding box of an upper layer. The method of hierarchically generating the bounding boxes by the electronic device is described with reference to FIG. 3, and a repeated description thereof is omitted.

In operation 420, according to an embodiment, the electronic device may extract candidate rays intersecting with an m-th bounding box among the total M child bounding boxes. For reference, M may be greater than or equal to m, and m may indicate an integer greater than or equal to 1. For example, assuming that M is 3, the electronic device may extract candidate rays intersecting with the first bounding box among three child bounding boxes.

In operation 430, the electronic device may determine whether to proceed with an intersection examination between the candidate rays and polygons based on a computation result between a number of polygons forming objects included in an m-th child bounding box and a number of candidate rays extracted from operation 420. For example, the electronic device may multiply the total number of polygons forming objects included in a first child bounding box by the number of candidate rays. The electronic device may compare the multiplication result with a predetermined threshold value. For example, the predetermined threshold value may be determined by a computing memory of the electronic device. The predetermined threshold value may indicate a computational limit of the electronic device. Accordingly, the electronic device may increase a value of n by 1 and perform operation 410 again when a value obtained by multiplying the number of polygons to be examined for an intersection by the number of candidate rays to be examined for an intersection exceeds the computational limit of the electronic device. In contrast, the electronic device may start an intersection examination between the polygons and the target rays when the value obtained by multiplying the number of polygons to be examined for an intersection and the number of candidate rays to be examined for an intersection falls within the computational limit of the electronic device.

In operation 440, it may be verified whether the values of m and M are the same. When the value of m is the same as the value of M, the electronic device may determine that the intersection examination of the rays for all bounding boxes included in a corresponding layer is terminated.

In operation 450, according to an embodiment, when the values of m and M are not the same, the electronic device may extract rays intersecting with at least one of the polygons included in the m-th bounding box. A method in which the electronic device extracts the rays intersecting with one of the polygons included in the bounding box according to one or more embodiments will be described in detail later with reference to FIGS. 7 and 8.

In operation 460, according to an embodiment, the electronic device may extract target rays by removing, from the candidate rays, the rays intersecting with the polygons included in the m-th bounding box. For example, the electronic device may extract a list of the rays intersecting with the polygons included in the m-th bounding box. The electronic device may remove the rays included in the extracted list of the rays from the candidate rays. For example, the rays intersecting with the polygons included in the m-th bounding box may indicate the rays in which a blockage has already occurred by an object. Accordingly, the electronic device may not consider the rays included in the list of the rays when performing a ray tracing computation on an (m+1)-th bounding box. The electronic device may repeatedly perform operations 420 to 460 until m becomes equal to M. The electronic device may dynamically index rays that are required for computing an intersection point with the polygons forming the objects, by repeatedly performing operations 420 to 460.

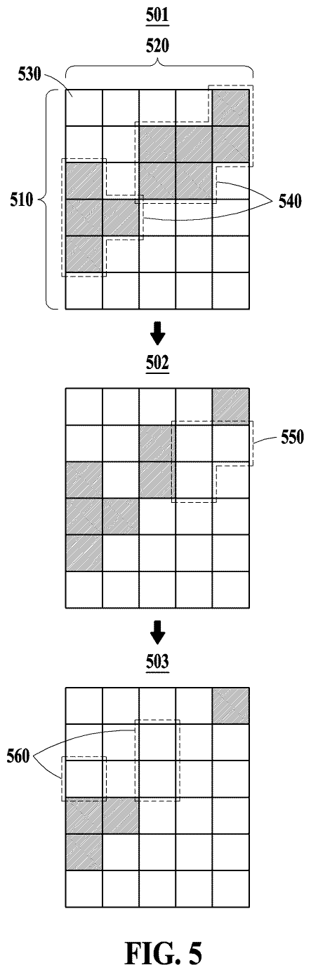

FIG. 5 illustrates a process in which a ray tracing computing device (hereinafter, referred to as an electronic device) dynamically indexes target rays, according to an embodiment.

Pieces of first, second, and third grid data 501, 502, and 503 shown in FIG. 5 may represent rays included in image data. For example, respective rows 510 of the pieces of first, second, and third grid data 501, 502, and 503 may indicate starting points of the rays. For example, a first row of the first grid data 501 may indicate a first starting point on the image data and a second row may indicate a second starting point on the image data. That is, different rows of the first grid data 501 may indicate different starting points of the rays. In addition, respective columns 520 of the pieces of first, second, and third grid data 501, 502, and 503 may indicate arrival points of the rays. For example, a first column of the first grid data 501 may indicate a first arrival point on the image data and a second column may indicate a second arrival point on the image data. That is, different columns of the first grid data 501 may indicate different arrival points of the rays. Each cell (e.g., a cell 530) forming the pieces of first, second, and third grid data 501, 502, and 503 may indicate a ray. For example, the cell 530 included in the first grid data 501 may indicate a cell located in the first row and the first column. Accordingly, the cell 530 may represent a ray propagating from the first starting point to the first arrival point on the image data. In a similar way, data mapped to a cell located in an a-th row and b-th column included in the pieces of first, second, and third grid data 501, 502, and 503 may represent a ray propagating from an a-th starting point to a b-th arrival point on the image data. Here, a and b may represent integers greater than or equal to 1.

For ease of description, the pieces of first, second, and third grid data 501, 502, and 503 may represent pieces of data indicating rays in each of bounding boxes included in the same layer. For example, the first grid data 501 may represent data indicating rays in a first bounding box included in a first layer. For example, the second grid data 502 may represent data indicating rays in a second bounding box included in the first layer. For example, the third grid data 503 may represent data indicating rays in a third bounding box included in the first layer.

Based on the pieces of first, second, and third grid data 501, 502, and 503, the electronic device may sequentially search for the bounding boxes included in the same layer and may express whether rays intersecting with a corresponding bounding box generate at least one intersection point with polygons forming objects included in the corresponding bounding box. For example, the electronic device may divide the first grid data 501 into cells indicating rays forming an intersection point with polygons forming objects included in the first bounding box and cells 540 indicating rays not forming the intersection point by performing operations 420 to 460 of FIG. 4 in the first bounding box. Thereafter, the electronic device may further perform operations 420 to 460 of FIG. 4 in the second bounding box following the first bounding box. The electronic device may divide the second grid data 502 into cells indicating rays forming an intersection point with polygons forming objects included in the second bounding box and cells indicating rays not forming the intersection point. However, when dividing the second grid data 502, the electronic device may further perform operations 420 to 460 of FIG. 4 based on the cells 540 divided in the first grid data 501. For example, the electronic device may remove cells 550 from the cells 540. Here, the cells 550 may be cells indicating the rays forming the intersection point with the polygons forming the objects included in the second bounding box. In a similar way, the electronic device may divide the third grid data 503 into cells indicating rays forming an intersection point with polygons forming objects included in the third bounding box and cells indicating rays not forming the intersection point. For example, the electronic device may remove cells 560 by further performing operations 420 to 460 of FIG. 4 based on cells in which the cells 550 are removed from the cells 540 in the third grid data 503. Accordingly, the electronic device may perform dynamic indexing that excludes rays intersecting with at least one of polygons forming objects included in a current bounding box from a ray tracing computation in a next bounding box. The electronic device may reduce an amount of collision examination computation in the ray tracing computation through a dynamic indexing method.

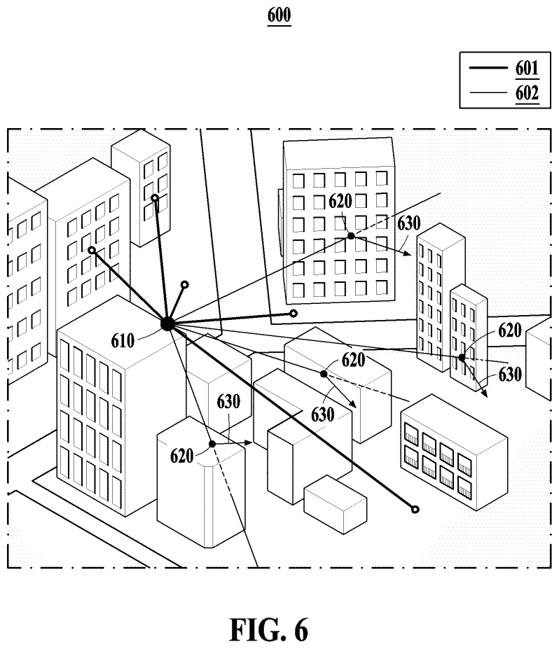

FIG. 6 is a diagram illustrating that a ray tracing computing device extracts target rays from among virtual rays expressed as starting points and arrival points on image data, according to an embodiment.

Image data 600 may include objects. As shown in FIG. 6, the objects may correspond to buildings but are not limited thereto, and the objects may correspond to obstacles, such as a tree, an installation, etc., other than buildings. According to an embodiment, a ray tracing computing device (hereinafter, referred to as an electronic device) may generate a bounding box (not shown) including at least one of the objects. In FIG. 6, for ease of description, it may be assumed that a bounding box is generated for each building shown in FIG. 6 and the generated bounding box is included in the same layer, which is a first layer.

According to an embodiment, the electronic device may locate a light source at a first point 610 of the image data 600. The electronic device may radially propagate virtual rays 601 and 602 generated from the first point 610. The virtual rays 601 of the virtual rays 601 and 602 may indicate rays not intersecting with the objects. The virtual rays 602 may indicate rays intersecting with at least one of polygons forming objects on a path of the rays from the first point 610 to an arrival point. The moving path of the virtual rays 602 may be changed as the virtual rays 602 are reflected, refracted, diffracted, and/or transmitted by objects at intersection points 620 intersecting with the polygons. The electronic device may generate second rays 630 in which a moving path of the virtual rays 602 is changed. For example, the electronic device may set the intersection points 620 as starting points of each of the second rays 630. The electronic device may determine arrival points of the second rays 630 as new points on the image data 600. The electronic device may set the second rays 630, which respectively connect the new points that are determined with corresponding intersection points 620. Accordingly, the electronic device may generate rays (e.g., the virtual rays 601 and 602 and the second rays 630) even when one light source is located on the image data 600. The electronic device may determine whether the generated rays intersect with a bounding box. The electronic device may perform a collision examination of the rays on all polygons of the objects included in the bounding box. However, an amount of computation may exceed a computational limit of the electronic device when the electronic device performs an intersection examination between all of the polygons forming objects included in the bounding box and the rays that may be generated based on a virtual starting point and an arrival point on the image data 600. In an example, the number of rays that may be generated may correspond to Nᵢₙ×Nₒᵤₜ when the electronic device sets Nᵢₙ, starting points and Nₒᵤₜ arrival points on the image data 600. The electronic device may need to perform the intersection examination as many times as Nᵢₙ×Nₒᵤₜ×N_{f} when the image data 600 includes a total of N_{f} polygons. A number of times the electronic device performs the intersection examination may affect a speed of a ray tracing computation. Accordingly, in performing the intersection examination between the rays and the polygons, the electronic device may need to classify the rays to be computed. An example of a method in which the electronic device extracts the target rays from among the virtual rays 601 and 602 and the second rays 630 shown in FIG. 6 is described in detail below with reference to Table 1.

TABLE 1

```
  $1 : {P}_{0 , 1}^{blob} is a blob box containing all vertices in map .$
  2: [symbol]   = ∅
  3:  i-th hierarchy:
  $4 : Devide {P}_{i - 1 , m}^{blob} into {M}_{i} blob boxes : {P}_{i , m}^{blob} , m ∈ \{ 1 , … , {M}_{i} \}$
  5:  for m = 1 : Mᵢ
  $6 : {ℐ}_{i , m} = \{ ( i , j ) \vert ( {p}_{i n , i} , {P}_{out , j} ) intersects {P}_{i , m}^{blob} \} ⋂ {ℬ}^{c}$
  $7 : {𝒦}_{i , m} = \{ k \vert {P}_{k} belongs to {P}_{i , m}^{blob} \}$
  8: if [symbol]   | × | [symbol]   < C
  9: [symbol]   = [symbol]  ∪ { (i, j) | (p_{in,i}, p_{out,j}) intersects Pₖ, (i, j) ∈ [symbol]   , k ∈ [symbol]  }
10: else
11:  Go to (i + 1)-th hierarchy
12:  end if
13:  end for
```

In Table 1,

$${P}_{i , m}^{blob}$$

denotes an m-th bounding box among bounding boxes included in an i-th layer. Pₖ denotes a k-th polygon among polygons included in one bounding box. [symbol] denotes target rays extracted from the m-th bounding box among the bounding boxes included in the i-th layer. [symbol] denotes polygons included in the m-th bounding box among the bounding boxes included in the i-th layer. In line 3 and line 4 of Table 1 above, the electronic device may divide one bounding box included in the i-th layer into a total of M lower bounding boxes included in an (i+1)-th layer. The electronic device may perform, by performing operations corresponding to lines 5 to 13 of Table 1, from an intersection examination on the lower bounding boxes included in the (i+1)-th layer with polygons included in a first lower bounding box to an intersection examination with polygons included in an m-th lower bounding box. In particular, the electronic device may extract target rays based on line 6 of Table 1. For example, in line 9 of Table 1, the electronic device may extract a set (e.g., [symbol] ) of rays intersecting with the polygons included in the m-th lower bounding box among the lower bounding boxes included in the (i+1)-th layer. An operation corresponding to line 9 of Table 1, which is performed by the electronic device, will be described in detail later with reference to FIGS. 7 and 8. The electronic device may then extract, as the target rays, from among candidate rays intersecting with an (m+1)-th bounding box, the rays that form an intersection with a complement set (e.g., [symbol] ) of the set extracted from line 9 of Table 1. That is, the electronic device may extract rays not intersecting with the polygons included in the m-th lower bounding box as the target rays.

FIGS. 7 and 8 are a flowchart and a diagram illustrating a method in which a ray tracing computing device performs an intersection examination between rays and polygons forming objects, according to embodiments.

In operation 710, according to an embodiment, based on a first ray and one vertex forming a target polygon among polygons, a ray tracing computing device (hereinafter, referred to as an electronic device) may calculate an intersection point between the first ray and a plane including the target polygon. Here, the first ray may indicate a ray intersecting with a first bounding box and not intersecting with polygons forming objects included in the first bounding box. Specifically, an operation of the electronic device is described with reference to FIG. 8.

FIG. 8 illustrates a case in which a first ray 801 and a target polygon 830 among polygons forming objects form one intersection point (that is, intersect at the one intersection point). In FIG. 8, for ease of description, it may be assumed that the target polygon 830 is a triangle. The electronic device may calculate parameters to be used in calculating the intersection point between the first ray 801 and a plane including the target polygon 830 with reference to Equation 1 below.

$$t = \frac{{n}^{T} ( {p}_{1} - {p}_{in} )}{{n}^{T} ( {p}_{o u t} - {p}_{i n} )} \qquad [ Equation 1 ]$$

In Equation 1, pᵢₙ denotes a vector value corresponding to a first point 810 indicating a starting point of the first ray 801. pₒᵤₜ denotes a vector value corresponding to a second point 820 indicating an arrival point of the first ray 801. p₁ denotes a vector value corresponding to a vertex 835 forming the target polygon 830. In addition, n may correspond to a normal vector 840 of the target polygon 830. According to an embodiment, the electronic device may calculate a first direction vector (e.g., pₒᵤₜ-pᵢₙ) from the first point 810 to the second point 820. The electronic device may produce a first dot product result (e.g., n^{T}(pₒᵤₜ-pᵢₙ)) obtained by performing a dot product on the first direction vector with the normal vector 840. The electronic device may calculate a second direction vector (e.g., p₁-pᵢₙ) from the first point 810 to the vertex 835. The electronic device may produce a second dot product result (e.g., n^{T}(p₁-pᵢₙ)) by performing a dot product on the second direction vector with the normal vector 840. The electronic device may produce a ratio (e.g., t) between the first dot product result and the second dot product result. The electronic device may calculate the intersection point between the first ray 801 and the plane including the target polygon 830 based on Equation 2 below, which includes the ratio between the first dot product result and the second dot product result as a parameter.

$${p}_{o n} = {p}_{i n} + t ( {p}_{o u t} - {p}_{i n} ) \qquad [ Equation 2 ]$$

In Equation 2, pₒₙ may correspond to the intersection point between the first ray 801 and the plane including the target polygon 830. According to an embodiment, the electronic device may determine whether the ratio between the first dot product result and the second dot product result falls within a first threshold range that is predetermined. For example, the electronic device may determine whether t is greater than 0 and less than 1. In FIG. 8, the first ray 801 may indicate a finite straight line having the first point 810 as a starting point and the second point 820 as an arrival point. Accordingly, when t is greater than or equal to 1, pₒₙ may be located further from the first point 810 than the second point 820. Accordingly, the electronic device may identify whether the intersection point is located in the first ray 801 by determining whether t falls within the first threshold range that is predetermined.

In operation 720, according to an embodiment, the electronic device may determine whether the intersection point is located inside the target polygon based on vector values corresponding to edges forming the target polygon and a vector value based on the one vertex and the intersection point.

Referring to FIG. 8, the electronic device may calculate vector values corresponding to each of a first edge and a second edge, which form the target polygon 830. For example, the target polygon 830 may include the vertex 835 and vertices 836 and 837. For example, the electronic device may calculate the vector value corresponding to the first edge based on the vertex 835 and the vertex 836. For example, the electronic device may calculate the vector value corresponding to the second edge based on the vertex 835 and the vertex 837. The electronic device may determine whether the intersection point is located inside the target polygon 830 with reference to Equation 3 below.

$$[ \begin{matrix}{r}_{1} \\ {r}_{2}\end{matrix} ] = {[ \begin{matrix}{p}_{2} - {p}_{1} & {p}_{3} - {p}_{1}\end{matrix} ]}^{†} ( {p}_{on} - {p}_{1} ) \qquad [ Equation 3 ]$$

In Equation 3, p₁ denotes a vector value corresponding to the vertex 835 forming the target polygon 830. p₂ denotes a vector value corresponding to the vertex 836 and denotes a vector value corresponding to the vertex 837. The electronic device may calculate vector values corresponding to the vertex 835 and the vertices 836 and 837. The electronic device may calculate a vector value (e.g., p₂-p₁) corresponding to the first edge in a direction from the vertex 835 to the vertex 836. The electronic device may calculate a vector value (e.g., p₃-p₁) corresponding to the second edge in a direction from the vertex 835 to the vertex 837. The electronic device may calculate a direction vector (e.g., pₒₙ-p₁) from the vertex 835 to the intersection point calculated based on Equations 1 and 2. The electronic device may perform a dot product on the calculated direction vector with a value obtained by conjugate-transposing data, which includes the vector value corresponding to the first edge and the vector value corresponding to the second edge. The electronic device may calculate distance weight values (e.g., r₁ and r₂) between the intersection point and each of the vertices 836 and 837, except for the vertex 835, based on the dot product result. The electronic device may determine whether each of the produced distance weight values falls within a second threshold range that is predetermined. For example, the electronic device may determine whether r₁ and r₂ exceed 0. In addition, the electronic device may determine whether a sum result (e.g., r₁+r₂) between the calculated distance weight values falls within a third threshold range (e.g., less than 1) that is predetermined. Accordingly, the electronic device may calculate the intersection point where the first ray 801 intersects with the target polygon 830 based on Equations 1 to 3 and may determine whether the calculated intersection point is located inside the target polygon 830.

According to an embodiment, as described with reference to FIGS. 7 to 8, the electronic device may perform the intersection examination between the rays and the polygons in parallel based on the rays and the polygons. For example, the electronic device may perform the intersection examination between the rays and the polygons in parallel based on an algorithm described in Table 2 below.

TABLE 2

$1 : {t}_{i , j , k} = \frac{{n}_{k}^{T} ( {p}_{k , 1} - {p}_{i n , i} )}{{n}_{k}^{T} ( {p}_{out , j} - {p}_{i n , i} )}$
2: p_{on,i,j,k} = p_{in,i} + t(p_{out,j} − p_{in,i})
$3 : [ \begin{matrix}{r}_{i , j , k , 1} \\ {r}_{i , j , k , 2}\end{matrix} ] = [ \begin{matrix}{p}_{k , 2} - {p}_{k , 1} & {{p}_{k , 3} - {p}_{k , 1} ]}^{†}\end{matrix} ( {p}_{o n , i , j , k} - {p}_{k , 1} )$
4: if 0 < t_{i,j,k} < 1 & r_{i,j,k,1} > 0 & r_{i,j,k,2} > 0 & r_{i,j,k,1} + r_{i,j,k,2} < 1
5: Declare (p_{in,i}, p_{out,j}) intersect Pₖ
6: end for

In Table 2, i may correspond to a layer, j may correspond to a bounding box in the layer, and k may correspond to a polygon in the bounding box. For example, denotes a parameter value calculated based on a k-th polygon included in a j-th bounding box among bounding boxes included in an i-th layer. The electronic device may determine (p_{in,i}, p_{out,j}) to be an intersection point between the k-th polygon and a ray when the produced parameter (e.g. t_{i,j,k}) and the produced distance weight values (e.g. r_{i,j,k,1} and . r_{i,j,k,2}) satisfy the condition described in row 4 of Table 2. When the condition described in row 4 of Table 2 is not satisfied, the electronic device may perform the algorithm described in Table 2 again starting from row 1 of Table 2.

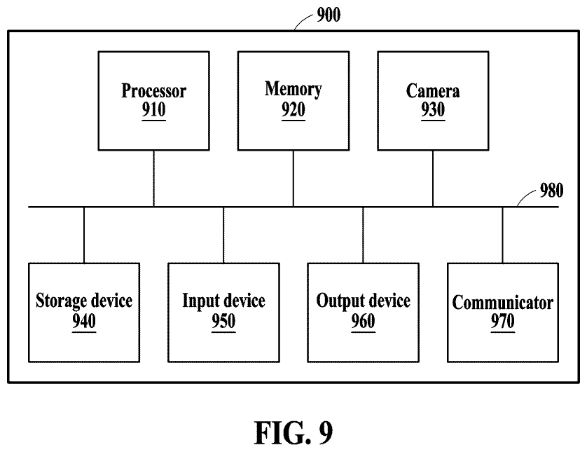

FIG. 9 is a block diagram illustrating an example of a configuration of a ray tracing computing device, according to an embodiment. Referring to FIG. 9, a ray tracing computing device 900 (hereinafter, referred to as an electronic device 900) may include at least one processor (hereinafter “processor”) 910, a memory 920, a camera 930, a storage device 940, an input device 950, an output device 960, and a communicator 970 that may communicate with each other via a communication bus 980. For example, the electronic device 900 may be implemented as at least a portion of a mobile device (e.g., a mobile phone, a smartphone, a personal digital assistant (PDA), a netbook, a tablet computer, a laptop computer, etc.), a wearable device (e.g., a smartwatch, a smart band, smart eyeglasses, etc.), a computing device (e.g., a desktop, a server, etc.), a home appliance (e.g., a television (TV), a smart TV, a refrigerator, etc.), a security device (e.g., a door lock, etc.), or a vehicle (e.g., an autonomous vehicle, a smart vehicle, etc.).

The processor 910 may execute instructions and functions in the electronic device 900. For example, the processor 910 may process instructions stored in the memory 920 or the storage device 940. The processor 910 may perform operations described with reference to FIGS. 1 to 8. The memory 920 may include a non-transitory computer-readable storage medium or a non-transitory computer-readable storage device. The memory 920 may store instructions that are to be executed by the processor 910 and store information associated with software and/or applications when the software and/or applications are being executed by the electronic device 900. For example, the memory 920 may store image data while operations of FIGS. 1 to 8 are performed by the electronic device 900.

The camera 930 may capture a photo and/or a video. For example, the camera 930 may capture image data. For example, the camera 930 may include an optical camera, light detection and ranging (LiDAR), etc., but is not limited thereto. The storage device 940 may include a non-transitory computer-readable storage medium or a non-transitory computer-readable storage device. The storage device 940 may store a greater amount of information than the memory 920 for a long time. For example, the storage device 940 may include a magnetic hard disk, an optical disc, flash memory, a floppy disk, or other non-volatile memories known in the art.

The input device 950 may receive an input from a user in an input manner through a keyboard and a mouse and/or in another input manner such as a touch input, a voice input, and an image input. For example, the input device 950 may include a keyboard, a mouse, a touch screen, a microphone, or any other device that detects the input from the user and transmit the detected input to the electronic device 900. The output device 960 may provide an output of the electronic device 900 to the user through a visual, auditory, and/or haptic channel. The output device 960 may include, for example, a display, a touch screen, a speaker, a vibration generator, or any other device that provides the output to the user. The output device 960 may output, for example, an image or a photo displaying virtual rays on image data.

The communicator 970 may communicate with an external device via a wired or wireless network. For example, the communicator 970 may obtain image data including objects from the external device.

The embodiments described herein may be implemented using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specifically configured to store and perform program instructions, such as read-only memory (ROM), random access memory (RAM), flash memory, and the like. Examples of program instructions include both machine code, such as one produced by a compiler, and files containing higher-level code that may be executed by the computer using an interpreter.

The above-described hardware devices may be configured to act as one or more software modules in order to perform the operations of the above-described embodiments, or vice versa.

As described above, although example embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A ray tracing computing method performed by at least one processor, the ray tracing computing method comprising:
obtaining image data comprising objects;
generating, in the image data, a first bounding box comprising at least one first object of the objects and a second bounding box comprising at least one second object of the objects, the second bounding box being distinguished from the first bounding box;
extracting, from among rays in the image data, candidate rays intersecting with the first bounding box;
extracting at least one target ray, based on the candidate rays and at least one first polygon corresponding to the at least one first object comprised in the first bounding box; and
examining an intersection between the at least one target ray and at least one second polygon corresponding to the at least one second object comprised in the second bounding box based on the at least one target ray and the second bounding box.

2. The ray tracing computing method of claim 1, wherein the extracting the at least one target ray comprises extracting the at least one target ray by removing, from the candidate rays, a ray intersecting with at least one of the at least one first polygon.

3. The ray tracing computing method of claim 1, wherein the at least one target ray comprises a first ray propagating from a first point to a second point, and
wherein the examining the intersection between the at least one target ray and the at least one second polygon comprises:
based on the first ray and a first vertex of a target polygon among the at least one second polygon, calculating an intersection point between the first ray and a plane comprising the target polygon; and
determining whether the intersection point is located inside the target polygon based on vector values corresponding to edges of the target polygon and a vector value based on the first vertex and the intersection point.

4. The ray tracing computing method of claim 3, wherein the calculating the intersection point comprises:
producing a first dot product result between a first direction vector from the first point to the second point and a normal vector corresponding to the target polygon;
producing a second dot product result between a second direction vector from the first point to the first vertex and the normal vector; and
calculating the intersection point based on a ratio between the first dot product result and the second dot product result.

5. The ray tracing computing method of claim 4, wherein the determining whether the intersection point is located inside the target polygon comprises producing distance weight values between the intersection point and each of other vertices, except for the first vertex, of the target polygon based on the vector values corresponding to the edges of the target polygon and a third direction vector from the first vertex to the intersection point.

6. The ray tracing computing method of claim 5, wherein the determining whether the intersection point is located inside the target polygon further comprises:
determining whether the ratio between the first dot product result and the second dot product result falls within a first threshold range that is predetermined;
determining whether each of the distance weight values falls within a second threshold range that is predetermined; and
determining whether a sum result of the distance weight values falls within a third threshold range that is predetermined.

7. The ray tracing computing method of claim 1, wherein the examining the intersection between the at least one target ray and the at least one second polygon comprises performing an intersection examination between the at least one target ray and the at least one second polygon based on a number of the candidate rays and a number of the at least one second polygon.

8. The ray tracing computing method of claim 1, wherein the generating the first bounding box and the second bounding box comprises:
setting the first bounding box and the second bounding box as parent bounding boxes corresponding to a first hierarchy; and
generating child bounding boxes comprising at least one of the at least one first object comprised in the first bounding box and corresponding to a second hierarchy, which is a lower hierarchy of the first hierarchy.

9. The ray tracing computing method of claim 1, wherein the generating the first bounding box and the second bounding box comprises:
obtaining predetermined coordinate axes corresponding to the image data; and
generating the first bounding box and the second bounding box, each of which comprises edges that are parallel to a direction of each of the predetermined coordinate axes.

10. The ray tracing computing method of claim 1, wherein the candidate rays comprise a first ray propagating from a first point to a second point and the extracting the candidate rays comprises:
setting an intersection point of the first ray with a target object among the objects as a starting point of a second ray, which is distinguished from the first ray;
setting the second ray based on the intersection point and a new point on the image data; and
determining whether the second ray and the first bounding box intersect with each other.

11. A non-transitory computer-readable storage medium storing computer program, the computer program being executable by at least one processor to perform:
obtaining image data comprising objects;
generating, in the image data, a first bounding box comprising at least one first object of the objects and a second bounding box comprising at least one second object of the objects, the second bounding box being distinguished from the first bounding box;
extracting, from among rays in the image data, candidate rays intersecting with the first bounding box;
extracting at least one target ray, based on the candidate rays and at least one first polygon corresponding to the at least one first object comprised in the first bounding box; and
examining an intersection between the at least one target ray and at least one second polygon corresponding to the at least one second object comprised in the second bounding box based on the at least one target ray and the second bounding box.

12. A ray tracing computing device comprising:
a communicator configured to obtain image data comprising objects;
a memory configured to store the image data and instructions; and
at least one processor configured to, by executing the instructions:
generate, in the image data, a first bounding box comprising at least one first object of the objects and a second bounding box comprising at least one second object of the objects, the second bounding box being distinguished from the first bounding box;
extract, from among rays in the image data, candidate rays intersecting with the first bounding box;
extract at least one target ray, based on the candidate rays and at least one first polygon corresponding to the at least one first object comprised in the first bounding box; and
examine an intersection between the at least one target ray and at least one second polygon corresponding to the at least one second object comprised in the second bounding box based on the at least one target ray and the second bounding box.

13. The ray tracing computing device of claim 12, wherein the at least one processor is configured to extract the at least one target ray by removing, from the candidate rays, a ray intersecting with at least one of the at least one first polygon.

14. The ray tracing computing device of claim 12, wherein the at least one target ray comprises a first ray propagating from a first point to a second point, and
wherein the at least one processor is configured to, based on the first ray and a first vertex of a target polygon among the at least one second polygon, calculate an intersection point between the first ray and a plane comprising the target polygon, and configured to determine whether the intersection point is located inside the target polygon based on vector values corresponding to edges of the target polygon and a vector value based on the first vertex and the intersection point.

15. The ray tracing computing device of claim 14, wherein the at least one processor is configured to, in calculating the intersection point, produce a first dot product result between a first direction vector from the first point to the second point and a normal vector corresponding to the target polygon, produce a second dot product result between a second direction vector from the first point to the first vertex and the normal vector, and calculate the intersection point based on a ratio between the first dot product result and the second dot product result.

16. The ray tracing computing device of claim 15, wherein the at least one processor is configured to determine whether the intersection point is located inside the target polygon by producing distance weight values between the intersection point and each of other vertices, except for the first vertex, of the at least one second polygon based on the vector values corresponding to the edges of the target polygon and a third direction vector from the first vertex to the intersection point.

17. The ray tracing computing device of claim 16, wherein the at least one processor is configured to determine whether the intersection point is located inside the target polygon by determining whether the ratio between the first dot product result and the second dot product result falls within a first threshold range that is predetermined, determining whether each of the distance weight values falls within a second threshold range that is predetermined, and determining whether a sum result of the distance weight values falls within a third threshold range that is predetermined.

18. The ray tracing computing device of claim 12, wherein the at least one processor is configured to perform an intersection examination between the at least one target ray and the at least one second polygon based on a number of the candidate rays and a number of the at least one second polygon.

19. The ray tracing computing device of claim 12, wherein the at least one processor is configured to set the first bounding box and the second bounding box as parent bounding boxes corresponding to the same hierarchy, a first hierarchy, and configured to generate child bounding boxes comprising at least one of the at least one first object comprised in the first bounding box and corresponding to a second hierarchy, which is a lower hierarchy of the first hierarchy.

20. The ray tracing computing device of claim 12, wherein the at least one processor is configured to obtain predetermined coordinate axes corresponding to the image data and configured to generate the first bounding box and the second bounding box, each of which comprises edges that are parallel to a direction of each of the predetermined coordinate axes.
